(19) United States
(12) Patent Application Publication
(10) Pub. No.: US 2026/0369721 A1
(43) Pub. Date: Nov. 19, 2026

(54) BATTERY THERMAL MANAGEMENT CONTROL METHOD BASED ON CELL MODULE HEATING FILM

(71) Applicant: FULLYMAX BATTERY CO., LTD., Huizhou (CN)

(72) Inventors: Wenbing ZHAN, Huizhou (CN); Jingyang ZHONG, Huizhou (CN); Yongcai GUO, Huizhou (CN); Changhao LIU, Huizhou (CN)

(73) Assignee: FULLYMAX BATTERY CO., LTD., Huizhou (CN)

(21) Appl. No.: 19/720,975

(22) Filed: Jun. 26, 2026

Related U.S. Application Data
(63) Continuation-in-part of application No. PCT/CN2023/082884, filed on Mar. 21, 2023.

(30) Foreign Application Priority Data
Dec. 27, 2022 (CN) 202211682606.9
Mar. 24, 2026 (CN) 202610370312.4

(51) Int. Cl. H01M 10/633; B64U 50/30; H01M 10/615; H01M 10/625; H01M 10/653; H01M 10/6551; H01M 10/6571

(52) U.S. Cl. CPC H01M 10/633; B64U 50/30; H01M 10/615; H01M 10/625; H01M 10/653; H01M 10/6551; H01M 10/6571; H01M 2220/20

(57) ABSTRACT

A battery thermal management control method includes: acquiring an operating temperature and a swelling pressure of the cell unit; performing temperature-swelling differential processing on the operating temperature and the swelling pressure to obtain a cell temperature rise rate and a cell swelling pressurization rate; detecting whether the cell temperature rise rate is greater than or equal to a preset temperature rise rate; if the cell temperature rise rate is greater than or equal to the preset temperature rise rate, detecting whether the cell swelling pressurization rate is greater than a preset swelling pressurization rate; if the cell swelling pressurization rate is greater than the preset swelling pressurization rate, sending a thermal runaway signal to a battery thermal management system to disconnect a charging/discharging circuit of the cell unit and an energizing circuit of each heating sheet.

### TECHNICAL FIELD

The present disclosure relates to batteries, and in particular to a battery thermal management control method based on a cell module heating film.

### BACKGROUND

In cold weather, the chemical reactions allowing a drone battery to operate slow down, thereby reducing its overall capacity. If a fully charged drone battery can provide 20-25 minutes of flight time in warm weather (59 °F or above), the flight time may drop to 10-15 minutes or less in cold weather. Therefore, pre-heating of the drone battery is required prior to flight, with a target temperature of about 75 °F (25 °C). The standard discharge requirements for lithium-ion cells generally specify an ambient temperature range of −20 °C to 60 °C; however, the allowable discharge rate is restricted in low-temperature environments, limiting the application of large currents for lithium-ion cells in low temperatures. To solve this problem, it is necessary to heat lithium-ion cells according to different rate discharge requirements. For example, by adding a heating film inside the cell module, the thermal safety of the cells can be ensured under the heating of the heating film, thereby guaranteeing the stability of high-current output of the cells.

Although existing heating films have made significant progress in solving the problem of temperature differences in battery cell heating, there are still issues in the following aspects:

The heating film has only a single function, mainly focusing on the heating function, without fully considering the swelling problem caused by rapid temperature rise of the cells;

The adaptability of the heating film to cell swelling is not explicitly addressed, a there is a lack of effective mitigation strategies for cell swelling, which represents a critical gap with respect to battery safety and lifespan;

Existing thermal runaway strategies are relatively simple and lack sufficient precision, making them unable to cope with more complex operating conditions or optimize performance.

### SUMMARY

The present disclosure is directed to a battery thermal management control method based on a cell module heating film that can improve the precision of battery cell thermal management.

The heating film is configured to heat a cell module of a battery, including a film strip and a sensing assembly. The film strip is configured to meander through the cell module, the film strip has a plurality of heating sheets and a plurality of interconnecting sheets, each of the interconnecting sheets is connected to two of the heating sheets, opposite sides of the heating sheet are respectively provided with cell units of the cell module, and each cell unit comprises at least one battery cell. The sensing assembly includes a plurality of temperature sensing members and a plurality of swelling sensing members arranged on the film strip, the temperature sensing members are configured to sample the temperature of each cell unit, the temperature sensing members comprise a plurality of temperature sensors arranged in an array; the swelling sensing members are configured to sample the surface pressure of each cell unit, the swelling sensing members comprise a plurality of swelling pressure sensors arranged in an array.

The battery thermal management control method may include: acquiring an operating temperature and a swelling pressure of the cell unit; performing temperature-swelling differential processing on the operating temperature and the swelling pressure to obtain a cell temperature rise rate and a cell swelling pressurization rate; detecting whether the cell temperature rise rate is greater than or equal to a preset temperature rise rate; if the cell temperature rise rate is greater than or equal to the preset temperature rise rate, detecting whether the cell swelling pressurization rate is greater than a preset swelling pressurization rate; if the cell swelling pressurization rate is greater than the preset swelling pressurization rate, sending a thermal runaway signal to a battery thermal management system to disconnect a charging/discharging circuit of the cell unit and an energizing circuit of each heating sheet.

In some embodiments, after detecting whether the cell swelling pressurization rate is greater than the preset swelling pressurization rate, the method further includes: if the cell swelling pressurization rate is less than or equal to the preset swelling pressurization rate, detecting whether the cell swelling pressurization rate is greater than a moderate swelling pressurization rate; if the cell swelling pressurization rate is greater than the moderate swelling pressurization rate, sending a moderate swelling runaway signal to the battery thermal management system to reduce a heating power of the heating sheet corresponding to the cell unit to a first power.

In some embodiments, the first power is 30% to 50% of the maximum power of the heating sheet.

In some embodiments, after detecting whether the cell swelling pressurization rate is greater than the moderate swelling pressurization rate, the method further includes: if the cell swelling pressurization rate is less than or equal to the moderate swelling pressurization rate, sending a slight swelling runaway signal to the battery thermal management system to reduce the heating power of the heating sheet corresponding to the cell unit to a second power.

In some embodiments, the second power is 80% to 95% of the maximum power of the heating sheet.

In some embodiments, after detecting whether the cell swelling pressurization rate is greater than the preset swelling pressurization rate, the method further includes: if the cell swelling pressurization rate is less than or equal to the preset swelling pressurization rate, acquiring the number of swollen cells of the cell unit; detecting whether the number of swollen cells is less than or equal to a first preset swelling number; when the number of swollen cells is less than or equal to the first preset swelling number, sending an isolated swelling signal to the battery thermal management system to reduce the heating power of the heating sheet corresponding to the swollen cell unit.

In some embodiments, after detecting whether the number of swollen cells is less than or equal to the preset swelling number, the method further includes: if the number of swollen cells is greater than the first preset swelling number, acquiring the number of non-adjacent swollen cells of the cell unit; detecting whether the number of non-adjacent swollen cells is greater than a second preset swelling number; when the number of non-adjacent swollen cells is greater than the second preset swelling number, sending a swelling suppression signal to the battery thermal management system to switch the cell module into a safety cooling mode.

In some embodiments, the second preset swelling number is 20% of the total number of cells in the cell module, and the second preset swelling number is greater than the first preset swelling number.

In some embodiments, after detecting whether the number of non-adjacent swollen cells is greater than the second preset swelling number, the method further includes: when the number of non-adjacent swollen cells is less than or equal to the second preset swelling number, acquiring the number of adjacent swollen cells of the cell unit; detecting whether the number of adjacent swollen cells is greater than a third preset swelling number; when the number of non-adjacent swollen cells is greater than the third preset swelling number, sending a cell forced cooling signal to the battery thermal management system to stop the heating of the heating sheet corresponding to the swollen cell unit and forcibly activate a local cooling mode.

In some embodiments, the third preset swelling number is greater than the first preset swelling number, and the third preset swelling number is less than the second preset swelling number.

In some embodiments, the heating sheet comprises a first flexible thermal conductive layer, a first insulating protective layer, a heating layer, a second insulating protective layer, and a second flexible thermal conductive layer, stacked in that sequence, and each of the first flexible thermal conductive layer and the second flexible thermal conductive layer abuts against a corresponding one of the cell units.

In some embodiments, each of the first flexible thermal conductive layer and the second flexible thermal conductive layer is made of a graphene composite material or flexible thermal conductive gel with a micro-grid structure.

In some embodiments, the material of the first insulating protective layer is a ultra-thin polyimide film.

In some embodiments, each heating sheet has bilateral heating zones and a centrally located sensing zone, heating wires are distributed in the heating zones, and the sensing zone is configured for placement of the temperature sensors and swelling pressure sensors.

In some embodiments, the heating zones and the sensing zone form an inverted “Ψ”-shaped structure.

Compared with the prior art, the present disclosure has at least the following advantages: after collecting the operating temperature and swelling pressure, the current charging/discharging state of the cell unit is determined. Subsequently, the operating temperature and swelling pressure are converted into corresponding cell temperature rise rate and battery cell swelling pressurization rate to determine the rates of temperature increase and swelling pressure change of the cell unit. Then, the cell temperature rise rate is compared with the preset temperature rise rate, and the battery cell swelling pressurization rate is compared with the preset swelling pressurization rate synchronously, facilitating the determination of the degree of swelling variation caused by temperature rise under the charging/discharging state of the cell unit. Finally, based on the degree of swelling variation due to temperature rise, the charging/discharging mode and heating mode of the cell unit are adjusted to provide real-time feedback regulation for thermal control of the cell unit, such that the thermal management state of the cell unit can be maintained in an optimal state at all times, thereby improving the precision of battery cell thermal management.

### BRIEF DESCRIPTION OF THE DRAWINGS

To describe the technical solutions in the embodiments of the present disclosure more clearly, the following briefly introduces the accompanying drawings required for describing the embodiments. Apparently, the accompanying drawings in the following description merely show some embodiments of the present disclosure, and a person of ordinary skill in the art may still derive other drawings from these accompanying drawings without creative efforts.

FIG. 1 is a flowchart of a battery thermal management control method based on a ce module heating film according to an embodiment;

FIG. 2 is a schematic diagram of a cell module heating film according to an embodiment;

FIG. 3 illustrates different layers of the cell module heating film of FIG. 2.

### DESCRIPTION OF THE EMBODIMENTS

To facilitate understanding of the present disclosure, the present disclosure will be described more comprehensively below with reference to relevant drawings which illustrate some embodiments of the present disclosure. However, the present disclosure can be implemented in many different forms and should not be construed as limited to the embodiments described herein. Rather, providing these embodiments enables a more thorough and complete understanding of the present disclosure.

It should be noted that when an element is referred to as being “fixed to” another element, it can be directly on that element or an intervening element may also be present. When an element is described to be “connected” to another element, it can be directly connected to that element or an intervening element may also be present. The terms “vertical,” “horizontal,” “left,” “right,” and similar expressions used herein are for illustrative purposes only and are not intended to limit the elements involved to these specific orientations.

Unless otherwise defined, all technical and scientific terms used herein have the same meaning as commonly understood by those skilled in the technical field of the present disclosure. The terms used herein are for the purpose of describing specific embodiments only and are not intended to limit the present disclosure. The term “and/or” used herein includes any and all combinations of one or more related listed items.

The present disclosure relates to a battery thermal management control method based on a cell module heating film. In one embodiment, the battery thermal management control method employs the heating film to heat a cell module of a battery. The heating film includes a film strip and a sensing assembly. The film strip is configured to meander through the cell module, the film strip has a plurality of heating sheets and a plurality of interconnecting sheets, each of the interconnecting sheets is connected to two of the heating sheets, opposite sides of the heating sheet are respectively provided with cell units of the cell module, and each cell unit comprises at least one battery cell. The sensing assembly comprises a plurality of temperature sensing members and a plurality of swelling sensing members arranged on the film strip, the temperature sensing members are configured to sample the temperature of each cell unit, the temperature sensing members comprise a plurality of temperature sensors arranged in a n array; the swelling sensing members are configured to sample the surface pressure of each cell unit, the swelling sensing members comprise a plurality of swelling pressure sensors arranged in an array.

The battery thermal management control method includes: acquiring an operating temperature and a swelling pressure of the cell unit; performing temperature-swelling differential processing on the operating temperature and the swelling pressure to obtain a cell temperature rise rate and a cell swelling pressurization rate; detecting whether the cell temperature rise rate is greater than or equal to a preset temperature rise rate; if the cell temperature rise rate is greater than or equal to the preset temperature rise rate, detecting whether the cell swelling pressurization rate is greater than a preset swelling pressurization rate; if the cell swelling pressurization rate is greater than the preset swelling pressurization rate, sending a thermal runaway signal to a battery thermal management system to disconnect a charging/discharging circuit of the cell unit and an energizing circuit of each heating sheet.

After collecting the operating temperature and swelling pressure, the current charging/discharging state of the cell unit is determined. Subsequently, the operating temperature and swelling pressure are converted into corresponding cell temperature rise rate and battery cell swelling pressurization rate to determine the rates of temperature increase and swelling pressure change of the cell unit. Then, the cell temperature rise rate is compared with the preset temperature rise rate, and the battery cell swelling pressurization rate is compared with the preset swelling pressurization rate synchronously, facilitating the determination of the degree of swelling variation caused by temperature rise under the charging/discharging state of the cell unit. Finally, based on the degree of swelling variation due to temperature rise, the charging/discharging mode and heating mode of the cell unit are adjusted to provide real-time feedback regulation for thermal control of the cell unit, such that the thermal management state of the cell unit can be maintained in an optimal state at all times, thereby improving the precision of battery cell thermal management.

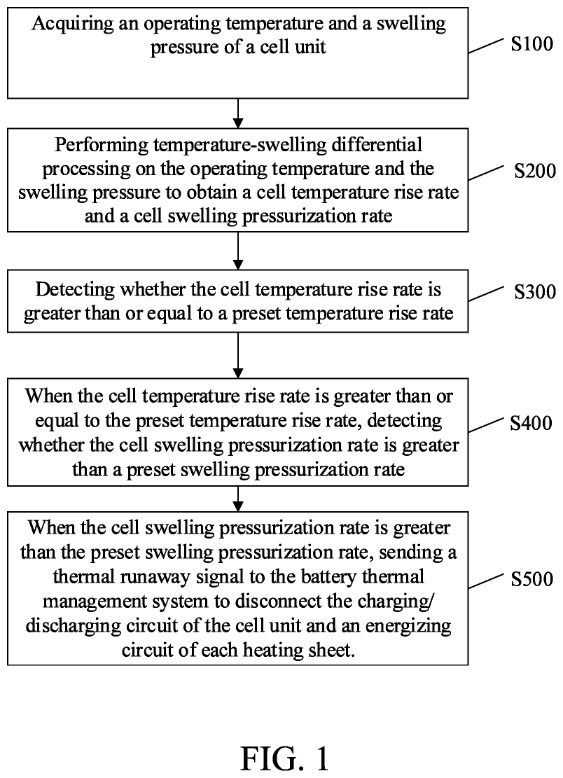

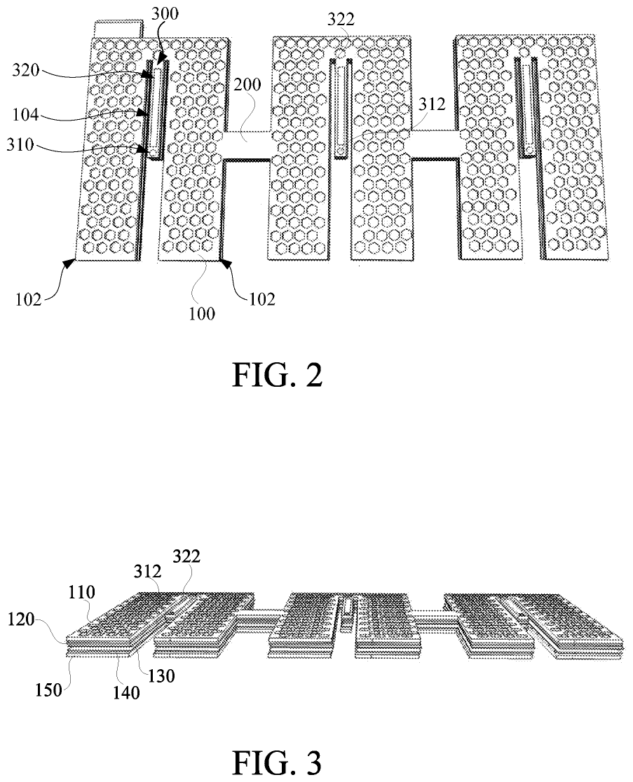

FIG. 1 is a flowchart of a battery thermal management control method based on a cell module heating film according to an embodiment of the present disclosure, which employs the heating film to heat a cell module of a battery. Referring also to FIG. 2, the heating film includes a film strip 10 and a sensing assembly (not shown in the figure). The film strip 10 is configured to meander through the cell module. The film strip 10 includes a plurality of heating sheets 100 and a plurality of interconnecting sheets 200. Each of the interconnecting sheets 200 is connected to two of the heating sheets 100. Opposite sides of the heating sheet 100 are respectively provided with cell units of the cell module, and each cell unit includes at least one battery cell. The sensing assembly includes a plurality of temperature sensing members and a plurality of swelling sensing members arranged on the film strip 10. The temperature sensing members are configured to sample the temperature of corresponding cell units. The temperature sensing members include a plurality of temperature sensors arranged in an array. The swelling sensing members are configured to sample the surface pressure of corresponding cell units. The swelling sensing members include a plurality of swelling pressure sensors arranged in an array. The battery thermal management control method includes some or all of the following steps.
S100: Acquiring an operating temperature and a swelling pressure of a cell unit.

In this embodiment, the cell unit is an individual cell group of the cell module. Specifically, the cell unit includes a plurality of battery cells arranged in an array. The film strip 10 passes through the cell module in a meandering path, so that the film strip 10 is distributed in a multi-bend path to simultaneously contact multiple cell units, thereby allowing the multiple cell units to be heated while being wrapped by the film strip 10. Each cell unit is provided with a corresponding heating sheet 100 for heating, i.e., each cell unit corresponds to at least one heating sheet 100. The operating temperature is the real-time surface temperature of the cell unit, tracked and sampled by the plurality of arrayed temperature sensors to determine the temperature condition of the cell unit during operation. The swelling pressure is the real-time surface pressure of the cell unit, which is tracked and sampled by the plurality of arrayed swelling pressure sensors to determine the swelling condition of the cell unit during operation.
S200: Performing temperature-swelling differential processing on the operating temperature and the swelling pressure to obtain a cell temperature rise rate and a cell swelling pressurization rate.

As described above, in this embodiment, the cell unit is an individual cell group of the cell module. Specifically, the cell unit includes a plurality of battery cells arranged in an array. The film strip 10 passes through the cell module in a meandering path, so that the film strip 10 is distributed in a multi-bend path to simultaneously contact multiple cell units, thereby allowing the multiple cell units to be heated while being wrapped by the film strip 10. Each cell unit is provided with a corresponding heating sheet 100 for heating, i.e., each cell unit corresponds to at least one heating sheet 100. The operating temperature is the real-time surface temperature of the cell unit, tracked and sampled by the plurality of arrayed temperature sensors to determine the temperature condition of the cell unit during operation. The swelling pressure is the real-time surface pressure of the cell unit, which is tracked and sampled by the plurality of arrayed swelling pressure sensors to determine the swelling condition of the cell unit during operation. In performing temperature-swelling differential processing on the operating temperature and swelling pressure, differentiation calculations are performed on the surface temperature and swelling pressure of the cell unit to obtain the temperature change rate and pressure change rate of the battery cell unit, thereby determining the temperature change trend and pressure change trend of the cell unit, facilitating the determination of the severity of swelling caused by temperature rise during operation. The cell temperature rise rate and cell swelling pressurization rate are obtained in real-time throughout the entire operation of the cell unit, even if the temperature of the cell unit is not at a thermal runaway threshold temperature.
S300: Detecting whether the cell temperature rise rate is greater than or equal to a preset temperature rise rate.

In this embodiment, the cell temperature rise rate is the surface temperature change rate of the cell unit, and the preset temperature rise rate corresponds to the surface temperature change rate of the cell unit in a safe charging/discharging state, i.e., the preset temperature rise rate is a standard surface temperature change rate of the cell unit. By comparing the cell temperature rise rate with the preset temperature rise rate, the rate of temperature change on the surface of the cell unit can be determined, thereby facilitating the determination of the temperature rise rate of the cell unit during charging/discharging, and thus facilitating the determination of abnormal surface temperature rise of the cell unit.
S400: When the cell temperature rise rate is greater than or equal to the preset temperature rise rate, detecting whether the cell swelling pressurization rate is greater than a preset swelling pressurization rate.

In this embodiment, the cell temperature rise rate being greater than or equal to the preset temperature rise rate indicates that the surface temperature rise rate of the cell unit exceeds the normal temperature rise rate, i.e., indicating that the cell unit is currently in a state of rapid temperature rise, which also indicates that the cell unit has a risk of thermal runaway. At this point, the rapid temperature rise of the cell unit may be caused by rapid charging/discharging or by thermal runaway. It is necessary to further determine the surface expansion condition of the cell unit, i.e., compare the cell swelling pressurization rate with the preset swelling pressurization rate. The cell swelling pressurization rate is the surface pressure change rate of the cell unit, i.e., the rate of increase of swelling pressure due to heating of the cell unit. The preset swelling pressurization rate is the standard surface pressure change rate of the cell unit, corresponding to the degree of swelling pressure change during normal charging/discharging of the cell unit. By comparing the cell swelling pressurization rate with the preset swelling pressurization rate, the swelling condition of the cell unit under rapid temperature rise conditions can be determined. This facilitates the determination of the impact of temperature changes on cell expansion, thereby facilitating the determination of whether the swelling of the cell unit is caused by thermal runaway.
S500: When the cell swelling pressurization rate is greater than the preset swelling pressurization rate, sending a thermal runaway signal to the battery thermal management system to disconnect the charging/discharging circuit of the cell unit and an energizing circuit of each heating sheet 100.

In this embodiment, the cell swelling pressurization rate being greater than the preset swelling pressurization rate indicates that the swelling pressure growth rate of the cell unit under rapid temperature rise conditions is too fast. This suggests that the rapid swelling of the cell unit is caused by thermal runaway, which also indicates that the cell unit is in a severe swelling state with extremely high risk. Such conditions may represent an early sign of thermal runaway or indicate severe damage to the battery structure. At this point, a thermal runaway signal is sent to the battery thermal management system to disconnect both the charge-discharge circuit of the cell unit and the energizing circuit of each heating sheet 100, which halts the operation of the thermally runaway cell unit and ceases heating of all heating sheets, directly triggering the highest level of safety protection measures. This can prevent further spread of thermal runaway of the cell unit, improving the precision of thermal management of the cell module.

In another embodiment, the control strategy for responding to a thermal runaway signal involves immediately disconnecting all heating circuits associated with the thermally runaway cell unit and its adjacent cell areas, while triggering the highest level of safety alarm. If the drone is in flight, the system will link with the flight control system to recommend executing an emergency landing or return procedure. At the same time, if there is an active cooling system, it will be forcibly activated to prevent thermal spread. In this state, the heating power is set to zero, proportional-integral-derivative (PID) control is terminated, a safety interrupt is triggered, directly overriding all heating control commands.

In the embodiments above, after collecting the operating temperature and swelling pressure, the current charging/discharging state of the cell unit is determined. Subsequently, the operating temperature and swelling pressure are converted into corresponding cell temperature rise rate and battery cell swelling pressurization rate to determine the rates of temperature increase and swelling pressure change of the cell unit. Then, the cell temperature rise rate is compared with the preset temperature rise rate, and the battery cell swelling pressurization rate is compared with the preset swelling pressurization rate synchronously, facilitating the determination of the degree of swelling variation caused by temperature rise under the charging/discharging state of the cell unit. Finally, based on the degree of swelling variation due to temperature rise, the charging/discharging mode and heating mode of the cell unit are adjusted to provide real-time feedback regulation for thermal control of the cell unit, such that the thermal management state of the cell unit can be maintained in an optimal state at all times, thereby improving the precision of battery cell thermal management.

In one embodiment, after detecting whether the cell swelling pressurization rate is greater than the preset swelling pressurization rate, the method further includes: if the cell swelling pressurization rate is less than or equal to the preset swelling pressurization rate, detecting whether the cell swelling pressurization rate is greater than a moderate swelling pressurization rate; when the battery cell swelling pressurization rate is greater than the moderate swelling pressurization rate, sending a moderate swelling runaway signal to the battery thermal management system to reduce the heating power of the heating sheet 100 corresponding to that cell unit to a first power.

In this embodiment, from a safety protection perspective, this graded control strategy establishes a progressive safety defense line, effectively avoiding the latency and misjudgment risks associated with single-threshold monitoring. When the cell swelling pressurization rate falls within the range between the moderate swelling pressurization rate and the preset swelling pressurization rate, it indicates that an abnormal reaction has occurred inside the cell unit, but it has not yet reached the critical state of severe runaway. This condition may signify electrolyte decomposition, gas generation, or severe lithium plating, posing potential safety risks. At this point, by sending a moderate swelling runaway signal to the battery thermal management system and reducing the heating power of the corresponding heating sheet 100 to the first power, specifically, for example, 30% to 50% of the maximum power of the heating sheet 100, the thermal reaction rate inside the cell unit can be suppressed at the source.

On one hand, reducing the heating power can reduce externally input heat, preventing further temperature rise inside the cell unit due to external heating, thereby slowing down the rate of electrolyte decomposition and side reactions between electrode materials; on the other hand, precise power adjustment can avoid excessive temperature gradients inside the cell unit caused by overcooling, preventing local stress concentration and exacerbating the swelling of the cell unit. Compared with the conventional crude control involving immediate shutdown upon fault detection, this stepwise intervention maximizes operational stability of the battery system while ensuring safety, providing valuable buffer time for vehicle driving or equipment operation, and reducing safety hazards caused by sudden failures.

In terms of extending battery life, the graded control strategy achieves refined conditioning of the cell unit, reducing battery life loss caused by over-control. Traditional swelling monitoring typically uses a single warning threshold; once the swelling degree of the cell unit approaches the threshold, it directly triggers intensive cooling or shutdown operations. While this ensures safety, frequent switching of operating conditions can cause repeated shocks to the internal structure of the cell unit, accelerating the aging and active attenuation of positive and negative electrode materials. The graded control strategy sets an intermediate threshold, i.e., the moderate swelling pressurization rate, performing gentle power adjustment when early signs of swelling appear in the cell unit, suppressing further development of swelling while avoiding excessive intervention in the cell unit. For example, in a low-temperature environment, the cell unit needs a certain heating power to maintain normal charging/discharging performance, but when moderate swelling occurs, moderately reducing the heating power can reduce side reactions caused by high temperatures while meeting basic performance requirements, thereby decelerating the aging process of the cell unit. In the long run, this refined control method can effectively improve the cycle life of the battery, reducing user costs and battery recycling pressure.

From the perspective of system energy consumption optimization, the graded control strategy achieves a dynamic balance between safety and energy efficiency. The energy consumption of the battery thermal management system is an important factor affecting the overall energy efficiency of the power battery system. Traditional fault control modes often adopt maximized cooling or heating operations to ensure safety, resulting in high system energy consumption. The graded control strategy performs precise power adjustment according to different degrees of cell unit swelling. In a moderate swelling state, the heating power is only reduced to the first power instead of directly shutting down the heating system or switching to maximum power cooling mode. This dynamic adjustment method can reduce the energy consumption of the thermal management system as much as possible while inhibiting swelling, improving the overall energy efficiency of the battery system. For example, during drone flight, when the battery cell unit shows moderate swelling, moderately reducing the heating power can reduce power consumption, thereby increasing the drone's endurance; in energy storage systems, this refined energy management can reduce operational costs and improve the economic benefits of energy storage projects.

In another embodiment, the control strategy for the moderate swelling runaway signal involves immediately lowering a target temperature of the cell unit area (e.g., from 25 °C to 15 °C) and significantly reducing the heating power. For example, the PID output power is limited to 30%-50% of the maximum power ( P_{actual}=P_{PID}·F_{swelling2}′ F_{swelling2}≈0.3~0.5). At the same time, the system triggers a first-level warning and suggests the user to inspect the battery. At this time, the adaptive PID switches its macroscopic operating condition to “swelling suppression mode,” loading a PID parameter set optimized for moderate swelling, while setting a lower target temperature.

Further, after detecting whether the cell swelling pressurization rate is greater than the moderate swelling pressurization rate, the method further includes: if the battery cell swelling pressurization rate is less than or equal to the moderate swelling pressurization rate, sending a slight swelling runaway signal to the battery thermal management system to reduce the heating power of the heating sheet 100 corresponding to that cell unit to a second power. In this embodiment, when the battery cell unit exhibits slight swelling, the internal gas production rate is slow, and the pressurization rate is at a low level; at this time, the external performance parameters of the cell unit may not exhibit significant variations, but the internal structure of the cell unit has begun to undergo gradual degradation. Such conditions are typically caused by thermal expansion during normal charging/discharging cycles or slight lithium plating, representing an acceptable degree of deformation. However, as the swelling degree intensifies, the rate of side reactions inside the cell unit accelerates, gas production increases sharply, and the pressurization rate rises rapidly. By setting the moderate swelling pressurization rate threshold, the swelling degree of the cell unit can be precisely graded.

When it is detected that the cell swelling pressurization rate is less than or equal to the moderate swelling pressurization rate, it is promptly determined that the cell unit is in a slight swelling runaway state, and a corresponding signal is sent to the battery thermal management system. This mechanism establishes a precise safety early warning line for the battery system. This early warning mechanism can issue alarms in the early stages of cell unit faults, securing valuable time for subsequent intervention and regulation, effectively preventing further deterioration of cell unit faults, and mitigating the risk of catastrophic safety accidents such as thermal runaway at the source.

When the battery thermal management system receives the slight swelling runaway signal and reduces the heating power of the corresponding heating sheet 100 to the second power, this regulation strategy can retard the development process of battery cell faults from multiple dimensions. From the perspective of internal chemical reactions of the battery cell, temperature is one of the key factors affecting the rate of chemical reactions inside the cell unit. When the cell unit is in a slight swelling runaway state, its internal side reactions have begun to accelerate, and excessively high temperature would further promote these side reactions, leading to accelerated gas production and rapid deterioration of the swelling degree of the cell unit. By reducing the heating power of the heating sheet 100, specifically, setting the second power to 80% to 95% of the maximum power of the heating sheet 100, the operating temperature of the cell unit can be effectively controlled, maintaining it within a relatively low and stable range. This lower operating temperature can suppress the rate of side reactions inside the cell unit, reduce gas production, thereby slowing down the development speed of swelling in the cell unit. At the same time, a suitable temperature environment helps maintain the stability of internal components such as electrode materials and electrolytes, thus reducing the rate of aging and damage, and extending the service life of the cell unit.

From the perspective of overall energy consumption of the battery system, reasonably reducing the heating power of the heating sheet 100 can reduce energy consumption in the thermal management aspect of the battery system. In application scenarios such as drones, the energy utilization rate of the battery system is directly related to the endurance of the drone. By precisely regulating the power of the heating sheet 100, unnecessary energy waste is avoided, which can improve the energy utilization efficiency of the battery system while ensuring the safety of the cell unit, enhancing the actual endurance performance of the drone. In addition, reducing the heating power of the heating sheet 100 can also reduce the loss of the heating sheet 100 itself, extending its service life and reducing the maintenance cost of the battery system.

In another embodiment, the control strategy for the slight swelling runaway signal involves maintaining the current heating target temperature (T_{target}), but reducing the heating rate (dT/dt) through an adaptive PID controller. Specifically, a swelling suppression factor F_{swelling1} (e.g., 0.8-0.95) is introduced in the PID algorithm, obtaining the actual output power according to P_{actual}=P_{PID}·F_{swelling1}. This aims to reduce thermal stress, retard swelling development, while not completely sacrificing heating efficiency. In the fuzzy logic fine-tuning of the adaptive PID, the swelling degree can be introduced as an additional input, or as a direct multiplier factor for PID parameter adjustment. For example: K_{p_final}=K_{p_base}·α·(1−C_{swelling1}), K_{i_final}=K_{i_base}·β·(1−C_{swelling1}), where C_{swelling1} is a coefficient positively correlated with the degree of slight swelling.

In one embodiment, after detecting whether the battery cell swelling pressurization rate is greater than the preset swelling pressurization rate, the method further includes: if the battery cell swelling pressurization rate is less than or equal to the preset swelling pressurization rate, acquiring the number of swollen cells of the cell unit; detecting whether the number of swollen cells is less than or equal to a first preset swelling number; if the number of swollen cells is less than or equal to the first preset swelling number, sending an isolated swelling signal to the battery thermal management system to reduce the heating power of the heating sheet 100 corresponding to the swollen cell unit. In this embodiment, the cell swelling pressurization rate directly reflects the gas production rate inside an individual battery cell, which is a key indicator for measuring the intensity of chemical reactions inside the cell unit. When early faults occur in the cell unit, the internal side reaction rate is relatively slow, gas production is relatively small, and the pressurization rate is at a low level; as the fault intensifies, the side reaction runs out of control, a large amount of gas accumulates, and the pressurization rate rises exponentially. Setting the preset swelling pressurization rate threshold establishes a “warning line” for the health status of the individual cell. Once the pressurization rate breaks through the threshold, it can be determined that the battery cell has entered a high-risk fault stage.

On this basis, the detection of the number of swollen cells is introduced to determine the total number of swollen cell units in the cell module (i.e., the number of swollen cells is the count of swollen cell units in the cell module), further evaluating the spread of faults at the system level. When the swelling pressurization rate of the battery cell unit is within the safe range, if multiple cell units swell simultaneously, it may indicate common hidden dangers in the cell module, such as abnormal ambient temperature or unreasonable charging/discharging strategies. The first preset swelling number threshold sets a “firewall” for fault spread at the system level. When the number of swollen cells does not exceed this threshold, it is determined to be an isolated expansion state of local battery cell units, e.g., only one cell unit in the cell module shows moderate or slight swelling, and its adjacent cell units are normal, avoiding affecting the overall normal operation of the cell module due to over-intervention; if it exceeds the threshold, higher-level fault response measures need to be activated. This dual-dimensional determination mechanism not only accurately identifies the fault degree of each cell unit, but also controls the spread trend of faults at the system level, achieving comprehensive and in-depth protection for battery safety.

After determining the “isolated swelling” state, an isolated swelling signal is sent the battery thermal management system to specifically reduce the heating power of the heating sheet 100 corresponding to the swollen cell unit. This regulation strategy can retard the development of cell faults at the source, thereby improving the service life and reliability of the battery system. From the perspective of internal chemical reactions of the battery cell, temperature is a core variable affecting the side reaction rate. When swelling occurs in the battery cell, internal side reactions are already in an accelerated state. If the heating sheet 100 maintains the original heating power, the battery cell temperature will continue to rise, further promoting side reactions, leading to accelerated gas production and rapid deterioration of the swelling degree of the cell unit. By reducing the heating power of the corresponding heating sheet 100, the operating temperature of the swollen cell unit can be precisely controlled, maintaining it within a relatively low range. A lower temperature environment can effectively suppress the rate of side reactions inside the cell unit, reduce gas production and accumulation, thereby slowing down the development of swelling in the cell unit, and preventing the fault from spreading from the isolated swelling state to a large area swelling state.

At the same time, this targeted power regulation method can minimize the impact on other normal cells while ensuring the safety of the swollen cell. Traditional thermal management systems often adopt a global regulation mode; when a single cell fails, the heating power of the entire battery pack is adjusted. This not only affects the operating performance of normal cells but also causes energy waste. The targeted regulation for swollen cell only adjusts the heating power of faulty cell, while other normal cells can still maintain the optimal operating temperature: for example, the heating power of the heating sheet 100 corresponding to each swollen cell unit is set to the second power, which is similar to the control strategy for the slight swelling runaway signal and is not repeated here. Thus, this strategy not only guarantees the overall performance of the battery system but also improves energy utilization efficiency and reduces operating costs of the battery system.

Further, after detecting whether the number of swollen cells is less than or equal to the preset swelling number, the method further includes: if the number of swollen cells is greater than a first preset swelling number, acquiring the number of non-adjacent swollen cells of the cell unit; detecting whether the number of non-adjacent swollen cells is greater than a second preset swelling number; if the number of non-adjacent swollen cells is greater than the second preset swelling number, sending a swelling suppression signal to the battery thermal management system to switch the cell module into a safety cooling mode.

In this embodiment, when the number of swollen cells is greater than the first preset swelling number, the system quickly enters the secondary detection phase to acquire the number of non-adjacent swollen cells of the cell unit. This design ingeniously leverages the propagation characteristics of cell swelling. The number of non-adjacent swollen cells provides an intuitive indication of whether the swelling issue is trending toward diffusion. Specifically, the number of non-adjacent swollen cells is the count of non-adjacent swollen cell units in the cell module, which also means the number of individually swollen cell units whose adjacent battery cell units are normal. If only adjacent battery cells exhibit swelling, it might be caused by local cell failures, and the risk is relatively controllable; but if many non-adjacent cells also exhibit swelling, it indicates the swelling issue may have spread, and the risk level increases significantly. By detecting the number of non-adjacent swollen cells, the system can precisely judge the diffusion trend of swelling risk, providing a precise basis for subsequent intervention measures.

When it is detected that the number of non-adjacent swollen cells is greater than the second preset swelling number, the system immediately sends a swelling suppression signal to the battery thermal management system to switch the cell module into a safety cooling mode. This intelligent intervention mechanism can take timely measures at an early stage of the risk, effectively curbing the further deterioration of the swelling. The safety cooling mode suppresses the development of cell swelling from multiple dimensions by precisely regulating the temperature environment of the cell module. On one hand, lowering the operating temperature of the cell module can slow down the rate of chemical reactions inside the cell unit and reduce gas production. Cell swelling primarily stems from accumulation of gases generated by electrolyte decomposition and side reactions at electrode materials, and excessively high temperature accelerates these chemical reactions. Through cooling treatment, gas generation can be reduced at the source, depressurizing the battery cell. On the other hand, reasonable temperature regulation can also improve the stability of internal materials of the battery cell, reducing the probability of damage to the cell structure. In high-temperature environments, materials such as separators and electrodes are prone to aging and deformation, which in turn exacerbate swelling. The safety cooling mode can provide a relatively stable temperature environment for the cells, extending the service life of the cells.

In addition, the safety cooling mode also has dynamic adjustment capabilities, enabling the precise adjustment of the cooling strategy based on real-time parameters such as temperature and swelling condition of the cell module. For example, when localized overheating of the cell module is detected, the system can intensify heat dissipation measures for that affected area; when the overall temperature stabilizes, the cooling intensity can be adjusted appropriately to avoid energy loss caused by overcooling. This dynamic adjustment mechanism not only improves the effectiveness of intervention measures but also considers the energy utilization efficiency of the battery system.

In another embodiment, the second preset swelling number is 20% of the total number of cells in the cell module, and the second preset swelling number is greater than the first preset swelling number. The control strategy for the swelling suppression signal is designed to address potential systemic anomalies, such as overcharge, over-discharge, or environmental stress by forcing the system into a safety cooling mode. For example, the power output of each heating sheet 100 is limited to the minimal holding level, and the module-level cooling system is prioritized for activation. The target temperature is uniformly adjusted below a safety threshold. At this time, the macroscopic operating condition switches to a module-level swelling suppression mode, all partitioned PID's target temperatures and parameters are uniformly adjusted, and a global power upper limit is applied across the entire system.

Further, after detecting whether the number of non-adjacent swollen cells is greater than the second preset swelling number, the method further includes: if the number of non-adjacent swollen cells is less than or equal to the second preset swelling number, acquiring the number of adjacent swollen cells of the cell unit; detecting whether the number of adjacent swollen cells is greater than a third preset swelling number; if the number of non-adjacent swollen cells is greater than the third preset swelling number, sending a cell forced cooling signal to the battery thermal management system to cease the heating of the heating sheet 100 corresponding to the swollen cell unit and forcibly start a local cooling mode. In this embodiment, when it is detected that the number of non-adjacent swollen cells is less than or equal to the second preset swelling number, the system does not directly determine that the risk is controllable but further acquires the number of adjacent swollen cells of the battery cell unit and compares it with the third preset swelling number. This design fully considers the propagation characteristics of cell swelling: adjacent cell swelling is often a direct manifestation of local faults, possibly caused by factors such as performance degradation of individual cells, early signs of local thermal runaway; whereas non-adjacent cell swelling better reflects the diffusivity of risk. By distinguishing between adjacent and non-adjacent swelling numbers, the system can precisely judge whether the risk is confined to a local area or has evolved into a cross-regional diffusion trend, thereby providing a refined basis for formulating subsequent prevention and control strategies. Here, the number of adjacent swollen cells is the adjacent count of swollen cell units in the cell module, i.e., the total number of adjacent swollen cell units.

Based on multi-level detection results, the system adopts differentiated prevention and control strategies, maximizing the reduction of impact on operational efficiency while ensuring battery safety. When the number of adjacent swollen cells is greater than the third preset swelling number, the system issues a cell forced cooling signal, implementing precise intervention through the combined measures of “stopping heating of the corresponding heating sheet 100 plus localized cooling.” On one hand, stopping the heating of the heating sheet 100 corresponding to the swollen cell unit directly cuts off local heat input, slowing down the rate of side reactions inside the cell unit at the source. One of the primary causes of cell swelling is the intensification of side reactions such as electrolyte decomposition and SEI film destruction in high-temperature environments. Stopping heating can quickly lower the surface temperature of the battery cell, suppressing the gas production rate. On the other hand, forced activation of the local cooling mode further strengthens the cooling effect through targeted heat dissipation. Unlike traditional pack-wide cooling modes, localized cooling only targets swollen cell units for precise heat dissipation, avoiding unnecessary cooling of normal cells, reducing energy loss, and ensuring the overall output efficiency of the battery pack. This “precise positioning plus targeted intervention” mode effectively curbs the deterioration of local swelling risks while avoiding performance losses caused by excessive prevention and control, achieving a dynamic balance between safety and efficiency.

In another embodiment, the third preset swelling number is greater than the first preset swelling number, and the third preset swelling number is less than the second preset swelling number. The number of non-adjacent swollen cells being greater than the third preset swelling number indicates that two or more physically adjacent cell units in the cell module simultaneously exhibit moderate or slight swelling, which is a typical precursor to thermal runaway propagation and carries extremely high risk. The control strategy for the cell forced cooling signal is that even if the swelling degree is only moderate or slight, the system immediately stops the power output of all heating modules in the affected area and forcibly activates localized cooling in that area. At the same time, a high-level warning is triggered, and the flight control system is advised to take emergency measures. This strategy aims to block the chain reaction of thermal runaway by rapidly cutting off the heat source and strengthening heat dissipation. At this time, the highest priority safety interrupt is triggered, directly disconnecting the heating circuit in the area where the adjacent swollen cell units are located, regardless of its PID output. This is a hard safety protection mechanism, prioritizing all heating demands.

In one embodiment, please also refer to FIG. 3, the heating sheet 100 includes a first flexible thermal conductive layer 110, a first insulating protective layer 120, a heating layer 130, a second insulating protective layer 140, and a second flexible thermal conductive layer 150, stacked in that sequence. Each of the first flexible thermal conductive layer 110 and the second flexible thermal conductive layer 150 abuts against a corresponding one of the cell units. In this embodiment, the first flexible thermal conductive layer 110 and the second flexible thermal conductive layer 150 serve as the layers directly contacting the cells, rapidly conducting the heat generated by the heating layer 130 to the cell units. Moreover, by virtue of their own flexible characteristics, these layers facilitate wrapping around the corresponding cell units, increasing the contact area with the cell units, thereby improving heat transfer efficiency. The first insulating protective layer 120 and the second flexible thermal conductive layer 150 electrically isolate and protect the heating layer 130, avoiding damage to the heating layer 130 and improving electrical safety.

In another embodiment, the first flexible thermal conductive layer 110 and the second flexible thermal conductive layer 150 are both made of a graphene composite material or flexible thermal conductive gel with a micro-grid structure, directly fitting the surface of the cells, and are configured to efficiently conduct heat and absorb minor deformations of the cells.

In another embodiment, the material of the first insulating protective layer 120 is a ultra-thin polyimide (PI) film, isolating the flexible thermal conductive layer from the internal heating element to ensure electrical safety. The second insulating protective layer 140 is a high-performance PI film, serving as a carrier substrate for the heating element, providing mechanical strength and secondary insulation protection. Moreover, the thicknesses of the first insulating protective layer 120 and the second insulating protective layer 140 are different; the thicker insulating protective layer is configured to carry printed temperature sensors and swelling pressure sensors, implemented for example in a flexible printed circuit (FPC) configuration.

In another embodiment, the heating layer 130 is implemented as a serpentine copper foil circuit manufactured using FPC technology, serving as the main heating element. The power of each heating layer 130 is independently controlled, and circuits of the respective heating layers 130 are consolidated into a single output port via an interconnecting sheet 200. Moreover, the heating layer 130 and various sensors are distributed in a staggered manner, realizing a spatially separated layout of the heating zone and sensing zone within the film strip 10. Specifically, the heating zone and sensing zone of the heating sheet 100 form an inverted “Ψ”-shaped structure. Heating wires are distributed in the heating zones, i.e., ultra-fine heating wires are densely distributed (implemented by FPC technology) on lateral side portions of each inverted “Ψ”-shape. The wiring density and power of these heating wires can be independently controlled to achieve refined zonal heating. The sensing zone is used to place temperature sensors and swelling pressure sensors, i.e., the middle concave area of the inverted “Ψ” shape is mainly used to place temperature sensors (thermistors) and swelling pressure sensors (piezoresistive sensors). This layout allows the sensors to directly monitor the temperature and swelling condition of the core area of the cells, while preventing direct interference with the sensor readings caused by the localized heat generated by the heating wires, improving measurement accuracy. Tiny, deformable gaps are preserved between each inverted “Ψ”-shaped module. These gaps help ensure that the heating film does not hinder cell swelling. When the cell swelling occurs, these gaps can be compressed or stretched, thereby absorbing the deformation of the cells, ensuring close contact of the heating film with the cells, while avoiding excessive mechanical stress on the heating wires and sensors. Please refer to FIG. 2, each heating sheet 100 can be further subdivided into three zones: bilateral heating zones 102 and a centrally located sensing zone 104. This partitioning separates the heating and sensing functions physically but integrates them tightly within one module, facilitating control and data acquisition. This inverted “Ψ” shaped modular design, combined with the tiny gaps between modules, can effectively address the adaptability of the heating film to cell deformation during swelling, while optimizing sensor layout and heat conduction paths.

In another embodiment, the interconnecting sheet 200 has a layer structure similar to that of the heating sheet 100, and has a three-layer structure. A middle layer of the interconnecting sheet 200 is configured for the passage of copper foil lines of each heating sheet 100, and insulating protective layers are provided on opposite sides of the middle layer to wrap the middle layer. The materials used for the layers of the interconnecting sheet 200 are the same as those of the corresponding layers of the heating sheet 100.

The above-described embodiments are merely illustrative of the principles and effects of the present disclosure and are not intended to limit the scope of the present disclosure. Those of ordinary skill in the art can make modifications and variations without departing from the spirit of the present disclosure. Therefore, the scope of protection of the present disclosure shall be determined by the appended claims.

What is claimed is:

1. A battery thermal management control method based on a heating film, the heating film configured to heat a cell module of a battery, the heating film comprising:
a film strip, wherein the film strip is configured to meander through the cell module, the film strip has a plurality of heating sheets and a plurality of interconnecting sheets, each of the interconnecting sheets is connected to two of the heating sheets, opposite sides of the heating sheet are respectively provided with cell units of the cell module, and each cell unit comprises at least one battery cell; and
a sensing assembly, wherein the sensing assembly comprises a plurality of temperature sensing members and a plurality of swelling sensing members arranged on the film strip, the temperature sensing members are configured to sample the temperature of each cell unit, the temperature sensing members comprise a plurality of temperature sensors arranged in an array; the swelling sensing members are configured to sample the surface pressure of each cell unit, the swelling sensing members comprise a plurality of swelling pressure sensors arranged in an array; and
wherein the battery thermal management control method comprises:
acquiring an operating temperature and a swelling pressure of the cell unit;
performing temperature-swelling differential processing on the operating temperature and the swelling pressure to obtain a cell temperature rise rate and a cell swelling pressurization rate;
detecting whether the cell temperature rise rate is greater than or equal to a preset temperature rise rate;
if the cell temperature rise rate is greater than or equal to the preset temperature rise rate, detecting whether the cell swelling pressurization rate is greater than a preset swelling pressurization rate;
if the cell swelling pressurization rate is greater than the preset swelling pressurization rate, sending a thermal runaway signal to a battery thermal management system to disconnect a charging/discharging circuit of the cell unit and an energizing circuit of each heating sheet.

2. The battery thermal management control method according to claim 1, wherein after detecting whether the cell swelling pressurization rate is greater than the preset swelling pressurization rate, the method further comprises:
if the cell swelling pressurization rate is less than or equal to the preset swelling pressurization rate, detecting whether the cell swelling pressurization rate is greater than a moderate swelling pressurization rate;
if the cell swelling pressurization rate is greater than the moderate swelling pressurization rate, sending a moderate swelling runaway signal to the battery thermal management system to reduce a heating power of the heating sheet corresponding to the cell unit to a first power.

3. The battery thermal management control method according to claim 2, wherein the first power is 30% to 50% of the maximum power of the heating sheet.

4. The battery thermal management control method according to claim 2, wherein after detecting whether the cell swelling pressurization rate is greater than the moderate swelling pressurization rate, the method further comprises:
if the cell swelling pressurization rate is less than or equal to the moderate swelling pressurization rate, sending a slight swelling runaway signal to the battery thermal management system to reduce the heating power of the heating sheet corresponding to the cell unit to a second power.

5. The battery thermal management control method according to claim 4, wherein the second power is 80% to 95% of the maximum power of the heating sheet.

6. The battery thermal management control method according to claim 1, wherein after detecting whether the cell swelling pressurization rate is greater than the preset swelling pressurization rate, the method further comprises:
if the cell swelling pressurization rate is less than or equal to the preset swelling pressurization rate, acquiring the number of swollen cells of the cell unit;
detecting whether the number of swollen cells is less than or equal to a first preset swelling number;
when the number of swollen cells is less than or equal to the first preset swelling number, sending an isolated swelling signal to the battery thermal management system to reduce the heating power of the heating sheet corresponding to the swollen cell unit.

7. The battery thermal management control method according to claim 6, wherein after detecting whether the number of swollen cells is less than or equal to the preset swelling number, the method further comprises:
if the number of swollen cells is greater than the first preset swelling number, acquiring the number of non-adjacent swollen cells of the cell unit;
detecting whether the number of non-adjacent swollen cells is greater than a second preset swelling number;
when the number of non-adjacent swollen cells is greater than the second preset swelling number, sending a swelling suppression signal to the battery thermal management system to switch the cell module into a safety cooling mode.

8. The battery thermal management control method according to claim 7, wherein the second preset swelling number is 20% of the total number of cells in the cell module, and the second preset swelling number is greater than the first preset swelling number.

9. The battery thermal management control method according to claim 7, wherein after detecting whether the number of non-adjacent swollen cells is greater than the second preset swelling number, the method further comprises:
when the number of non-adjacent swollen cells is less than or equal to the second preset swelling number, acquiring the number of adjacent swollen cells of the cell unit;
detecting whether the number of adjacent swollen cells is greater than a third preset swelling number;
when the number of non-adjacent swollen cells is greater than the third preset swelling number, sending a cell forced cooling signal to the battery thermal management system to stop the heating of the heating sheet corresponding to the swollen cell unit and forcibly activate a local cooling mode.

10. The battery thermal management control method according to claim 9, wherein the third preset swelling number is greater than the first preset swelling number, and the third preset swelling number is less than the second preset swelling number.

11. The battery thermal management control method according to claim 1, wherein the heating sheet comprises a first flexible thermal conductive layer, a first insulating protective layer, a heating layer, a second insulating protective layer, and a second flexible thermal conductive layer, stacked in that sequence, and each of the first flexible thermal conductive layer and the second flexible thermal conductive layer abuts against a corresponding one of the cell units.

12. The battery thermal management control method according to claim 11, wherein each of the first flexible thermal conductive layer and the second flexible thermal conductive layer is made of a graphene composite material or flexible thermal conductive gel with a micro-grid structure.

13. The battery thermal management control method according to claim 11, wherein the material of the first insulating protective layer is a ultra-thin polyimide film.

14. The battery thermal management control method according to claim 1, wherein each heating sheet has bilateral heating zones and a centrally located sensing zone, heating wires are distributed in the heating zones, and the sensing zone is configured for placement of the temperature sensors and swelling pressure sensors.

15. The battery thermal management control method according to claim 14, wherein the heating zones and the sensing zone form an inverted “Ψ”-shaped structure.
